(19) United States
(12) Patent Application Publication
(10) Pub. No.: US 2025/0389533 A1
(43) Pub. Date: Dec. 25, 2025

(54) System and Method of Measuring an Optical Surface by Collimating a Divergent Beam

(71) Applicant: Gaston Daniel Baudat, Columbus, IN (US)

(72) Inventor: Gaston Daniel Baudat, Columbus, IN (US)

(21) Appl. No.: 19/250,049

(22) Filed: Jun. 25, 2025

Related U.S. Application Data
(60) Provisional application No. 63/664,038, filed on Jun. 25, 2024.

(51) Int. Cl. G01B 11/24; G01M 11/00; G06T 7/521

(52) U.S. Cl. CPC G01B 11/2441; G01M 11/005; G06T 7/521; G06T 2207/20081

(57) ABSTRACT

A method implemented by an optical system and a computing system allows for measuring of an optical surface by collimating a divergent beam. A divergent beam is emitted from the beam transceiver, to the testing surface, and to the referenceable collimator in order to convert the divergent beam into a convergent beam. The convergent beam is then reflected from the referenceable collimator, to the testing surface, and to the beam transceiver. The beam transceiver then captures a current image of the convergent beam. The computing system then executes an estimation process by inputting the current image into the estimation process. The computing system finally executes the estimation process with the computing system by outputting a surface profile of the testing surface with the estimation process.

The current application claims a priority to the U.S. provisional patent application Ser. No. 63/664,038 filed on Jun. 24, 2024.

### FIELD OF THE INVENTION

The present invention generally relates to the field of optical metrology and related measurements. More specifically, the present invention is the Ritchey-Common test and similar methods using AI image space phase retrieval.

### BACKGROUND OF THE INVENTION

The present invention is a general approach/method to measure optical surfaces in reflection and/or transmission when the incoming beam is not a simple plane wave. Among such tests are the Hindle test for measuring convex surfaces and the Ritchey-Common (RC) test for flat, concave, or convex surfaces. The concept will be explained using the RC test as a general example. However, it should be obvious to anyone skilled in the field of optical metrology and related measurements that the present invention is not limited to the specific configurations mentioned. It can also be applied to other setups involving a measuring beam, or beams (either incoming and/or outgoing) that are not plane waves (collimated beams). In more general terms, this method deals with configurations where the relationship between the wavefront of the beam, or beams (incoming or return beam, or beams) used to measure the surface and the surface itself is not trivial, unlike a simple factor. The wavefront encodes the surface in a complex and often non-linear way. The following is an example of the implementation of such an approach, but it is not a limitation or exhaustive in any way.

The Ritchey-Common (RC) test is a widely used optical method for testing large plane mirrors, initially proposed by A. A. Common in 1888 and detailed by G. H. Ritchey in 1904. The RC test extends the Foucault test for spherical surfaces by placing a flat mirror in the path of a diverging beam reflected off a spherical mirror. If the reference sphere is perfect, the setup is auto-stigmatic, perfectly imaging a point source back on itself. Residual power in the flat introduces some astigmatism too. Today, the RC test is often done using interferometry, positioning the point source at the reference sphere's center of curvature. This approach generates interferograms that require specific data reduction techniques due to the unique setup where light does not strike the test piece at normal incidence. Sec FIG. 11 for RC typical setup.

The source setup creates an outgoing spherical diverging beam to be reflected by the surface under test and the reference spherical mirror, resulting in an incoming (return) converging beam. The source is positioned at the center of curvature (CC) of the spherical mirror, which acts as a reference. In the simple case where the surface under test is flat, the return incoming beam is imaged at the spherical mirror's CC, or near it. In the context of interferometry, a transmission sphere can be used to create the outgoing beam, which eventually interferes with the incoming beam reflected back from the spherical mirror and the surface under test. This setup constitutes a double-pass test. The angle theta, known as Ritchey's angle, is critical in this setup. The combination of the diverging nature of the outgoing beam and the angle theta (typically not zero in the RC test) creates a specific non-linear mapping between the profile of the surface under test and the wavefront of the incoming beam. This mapping is a crucial aspect of the RC test and similar tests. Data reduction is necessary to relate the measured wavefront (obtained from an interferometer, a wavefront sensor, or using image space phase retrieval or phase diversity methods) to the optical surface deformation (profile) under test. Several mappings have been developed to address this issue, such as those proposed by T. A. Fritz (see “Interferometric Evaluation for a Ritchey-Common Test Configuration,” M. S. Thesis, U. Arizona, Tucson, 1980). The present invention is a method to directly retrieve the surface profile from the image formed by the incoming beam using AI. This is related to Innovations Foresight's AI4Wave technology, which has been used for phase retrieval (i.e., U.S. Pat. No. 11,300,445—System and Method for Wavefront Sensing with Engineered Images) (i.e., U.S. Pat. No. 11,300,445 is incorporated by reference). Here, the RC test is used as an example of a possible implementation of such an approach, but it is not a limitation. Also, this approach can be implemented in reflection, transmission, or a combination of both. For instance, it can be used to measure both sides of a transparent surface, including its thickness.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram illustrating the system of the present invention.

FIG. 2 is a flowchart illustrating an overall process for the method of the present invention.

FIG. 3 is a flowchart illustrating a subprocess of using the Ritchey-Common test.

FIG. 4 is a flowchart illustrating a subprocess of improving the image-quality of a current image of a divergent beam.

FIG. 5 is a flowchart illustrating a subprocess of using a non-linear mapping function to compute a surface profile of a testing surface.

FIG. 6 is a flowchart illustrating a subprocess of training an artificial intelligence model.

FIG. 7 is a flowchart illustrating a subprocess of estimating a surface characteristic of a testing surface.

FIG. 8 is a flowchart illustrating a subprocess of using a stop within an optical system.

FIG. 9 is a flowchart illustrating a subprocess of moving a stop within an optical system.

FIG. 10 is a flowchart illustrating a subprocess of using a mask within an optical system.

FIG. 11 is a drawing depicting the Ritchey-Common (RC) test configuration.

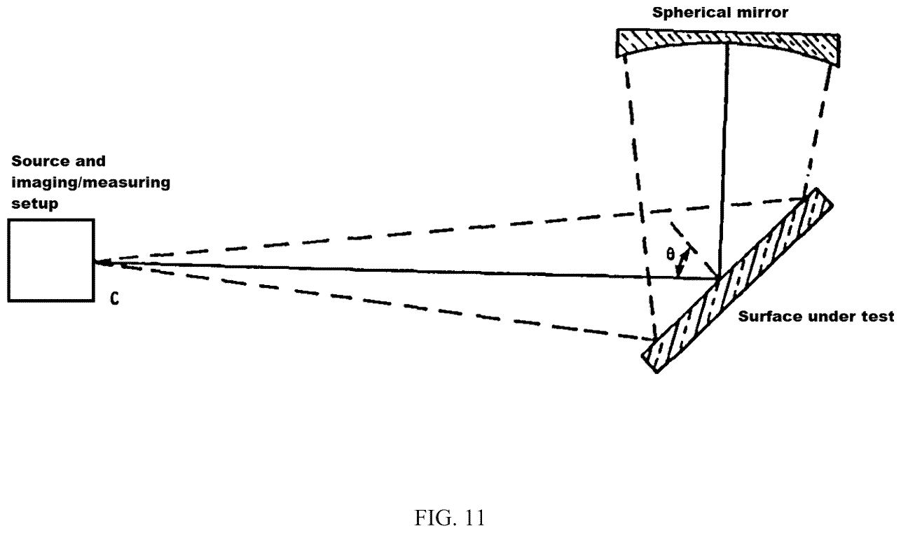

FIG. 12 is a drawing depicting RC test defocused shape versus system's stop location (theta=90 degrees).

FIG. 13 is a drawing depicting RC test surface error 2D heat plot, related defocused images, and wavefront 2D heat plots, theta=30 degrees and beam at f/2, and surface departure expressed using circular Zernike polynomials, all values in wave RMS.

FIG. 14 is a drawing depicting the synopsis of training the inverse function relating defocused images to surface departure from flat, using Zernike polynomials.

FIG. 15 is a drawing depicting the double-sided reflecting RCT test.

FIG. 16 is a drawing depicting the flat window measurement using RC test in reflection (red rays) and transmission (green rays), and each sensor captures two primary images: one from the reflection source and one from the transmission source, and the flat window's internal reflections are not considered here.

FIG. 17 is a drawing depicting some internal reflections from the flat window under test, the spherical mirror (which should be located at the bottom of this figure) has been omitted for simplicity, and the incoming rays are therefore not considered here.

FIG. 18 is a drawing depicting the RC test with a moving stop in front of the spherical mirror, and the defocused images exhibit a circular shape since the stop acts as the system stop now.

### DETAILED DESCRIPTION OF THE INVENTION

All illustrations of the drawings are for the purpose of describing selected versions of the present invention and are not intended to limit the scope of the present invention.

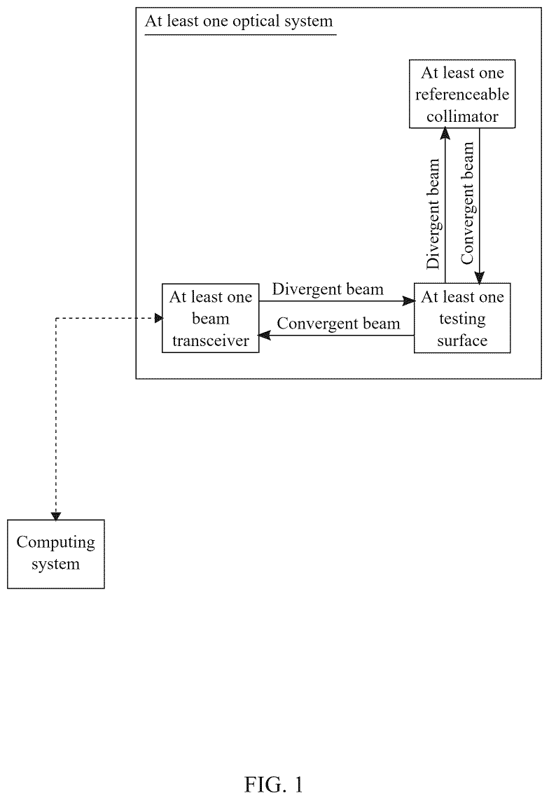

The present invention is a system and a method of measuring an optical surface by collimating a divergent beam. As can be seen in FIG. 1, the system for the present invention includes a computing system and at least one optical system (Step A). The optical system includes at least one beam transceiver, at least one testing surface, and at least one referenceable collimator. The beam transceiver originates and terminates a beam travelling through the optical system. The testing surface is the portion of the optical system that is being tested or measured by the present invention. The referenceable collimator provides a measurement reference for the tested surface and collimates a beam travelling through the optical system so that the beam can be easily captured by the beam transceiver. The computing system and the beam transceiver are communicably coupled to each other so that the computing system and the beam transceiver can digitally communicate with each other. The beam transceiver, the testing surface, and the beam collimator are in optical communication with each other, which allows the present invention to eventually test or measure the tested surface.

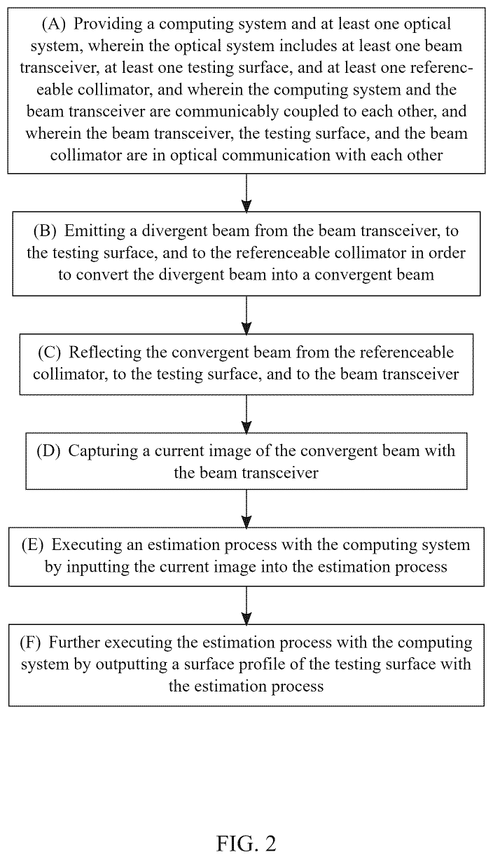

As can be seen in FIG. 2, the method of the present invention follows an overall process that allows for efficient and effective measurements of an optical surface by using an image captured from a returning beam, instead of a wavefront. The overall process begins by emitting a divergent beam from the beam transceiver, to the testing surface, and to the referenceable collimator in order to convert the divergent beam into a convergent beam (Step B). The overall process continues by reflecting the convergent beam from the referenceable collimator, to the testing surface, and to the beam transceiver (Step C). The overall process continues by capturing a current image of the convergent beam with the beam transceiver (Step D) so that the present invention does not rely on wavefront reconstruction of the convergent beam to measure the tested surface. The overall process continues by executing an estimation process with the computing system by inputting the current image into the estimation process (Step E). The overall process concludes by further executing the estimation process with the computing system by outputting a surface profile of the testing surface with the estimation process (Step F).

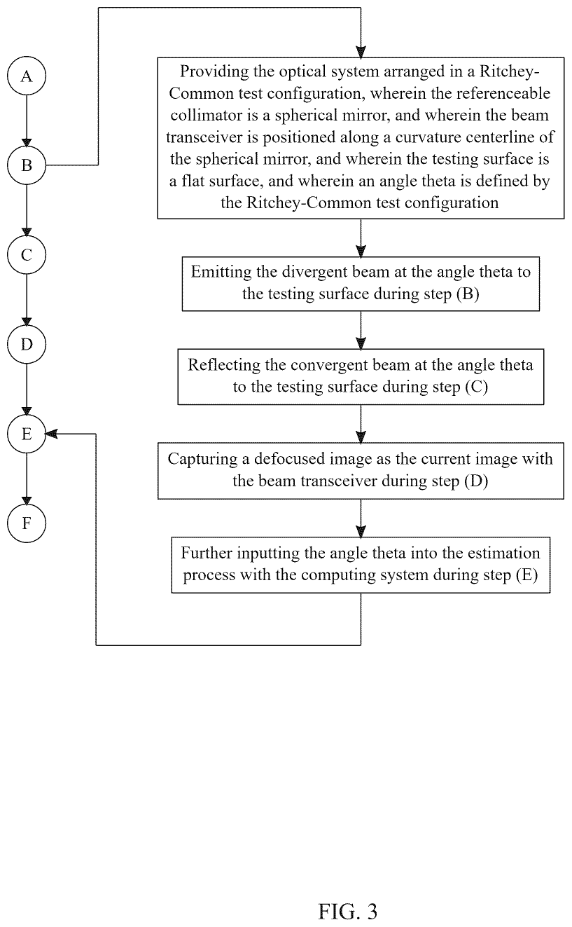

As can be seen in FIG. 3, a subprocess for the method of the present invention provides the optical system arranged in a Richey-Common test configuration. The referenceable collimator is a spherical mirror. The beam transceiver is positioned along a curvature centerline of the spherical mirror. The testing surface is a flat surface. An angle theta is defined by the Ritchey-Common test configuration. Thus, this subprocess begins by emitting the divergent beam at the angle theta to the testing surface during Step B.

This subprocess continues by reflecting the convergent beam at the angle theta to the testing surface during Step C. This subprocess continues capturing a defocused image as the current image with the beam transceiver during Step D. This subprocess concludes by further inputting the angle theta into the estimation process with the computing system during Step E.

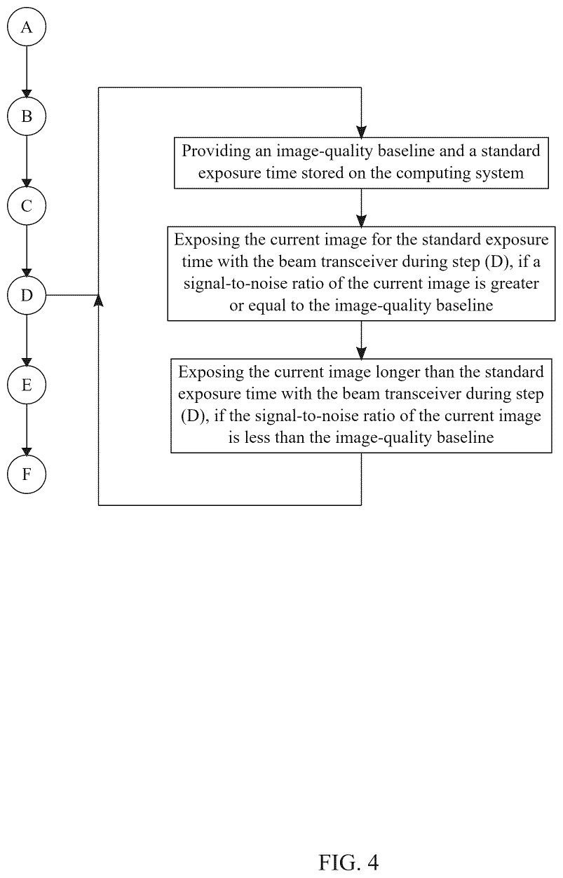

As can be seen in FIG. 4, another subprocess for the method of the present invention provides an image-quality baseline and a standard exposure time stored on the computing system in order to improve the image quality of the current image. Thus, the beam transceiver exposes the current image for the standard exposure time during Step D, if a signal-to-noise ratio of the current image is greater or equal to the image-quality baseline. Otherwise, the beam transceiver exposes the current image longer than the standard exposure time during Step D, if the signal-to-noise ratio of the current image is less than the image-quality baseline.

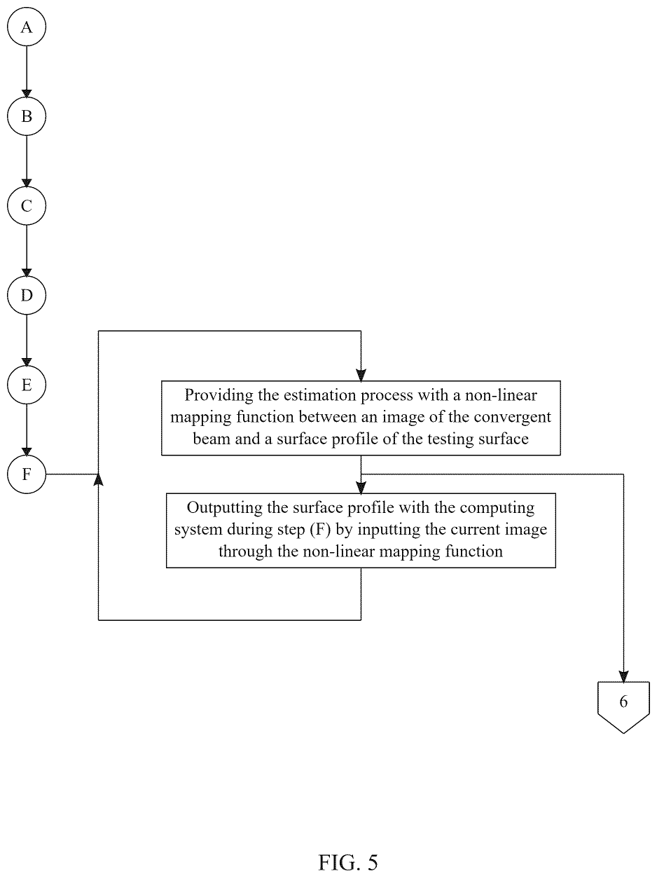

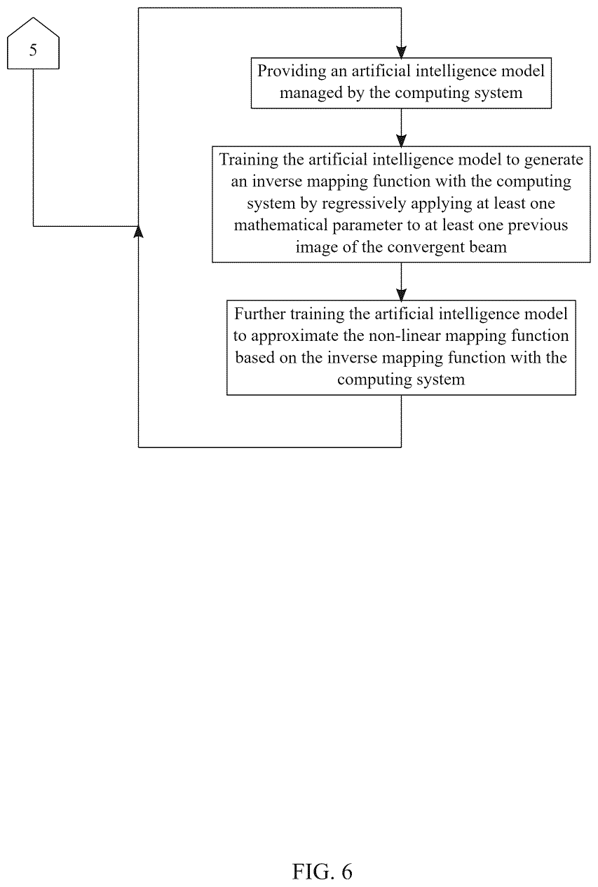

As can be seen in FIG. 5, another subprocess for the method of the present invention provides the estimation process with a non-linear mapping function between an image of the convergent beam and a surface profile of the testing surface. Thus, the computing system outputs the surface profile with the computing system during Step F by inputting the current image through the non-linear mapping function. More specifically, an artificial intelligence model is managed by the computing system, which is shown in FIG. 6. The computing system can consequently train the artificial intelligence model to generate an inverse mapping function by regressively applying at least one mathematical parameter to at least one previous image of the convergent beam. For example, if the testing surface is a circular surface or an elliptical surface, the mathematical parameter can be a set of Zernike polynomial coefficients to define the testing surface. The computing system can further train the artificial intelligence model to approximate the non-linear mapping function based on the inverse mapping function.

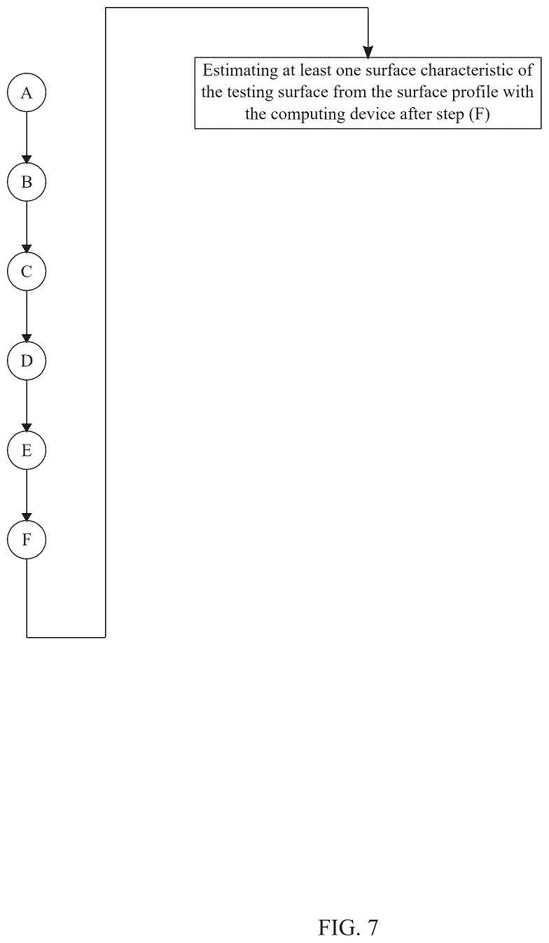

As can be seen in FIG. 7, another subprocess for the method of the present invention specifies the surface profile. Thus, this subprocess allows at least one surface characteristic of the testing surface to be estimated from the surface profile with the computing device after Step F. More specifically, the surface characteristic can be a deviation from flatness, a surface thickness, an index of refraction, a level of transparency, a surface polarization, or a combination thereof.

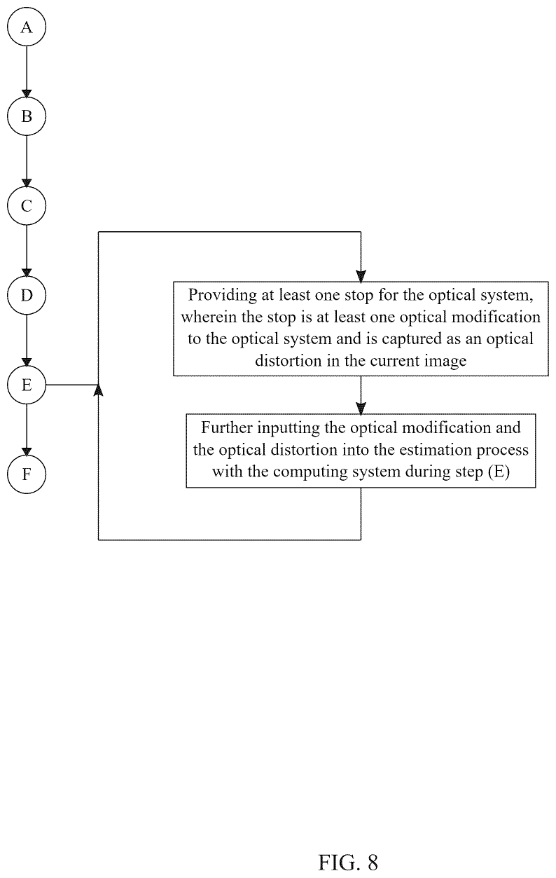

As can be seen in FIG. 8, another subprocess for the method of the present invention is provided with at least one stop for the optical system. The stop is used to sample the divergent beam and/or the convergent beam. Both ML and classical approaches can take advantage of this, including for simpler system calibration. The stop is at least one optical modification to the optical system and is captured as an optical distortion in the current image. Thus, this subprocess is executed by further inputting the optical modification and the optical distortion into the estimation process with the computing system during Step E.

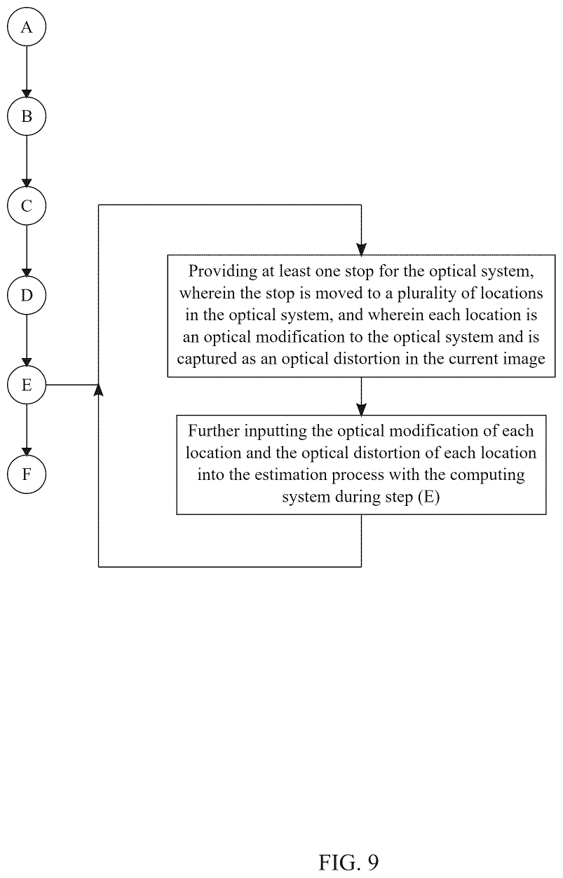

As can be seen in FIG. 9, another subprocess for the method of the present invention is provided with at least one stop for the optical system. The stop is moved to a plurality of locations in the optical system. Each location is an optical modification to the optical system and is captured as an optical distortion in the current image. Thus, this subprocess is executed by further inputting the optical modification of each location and the optical distortion of each location into the estimation process with the computing system during Step E.

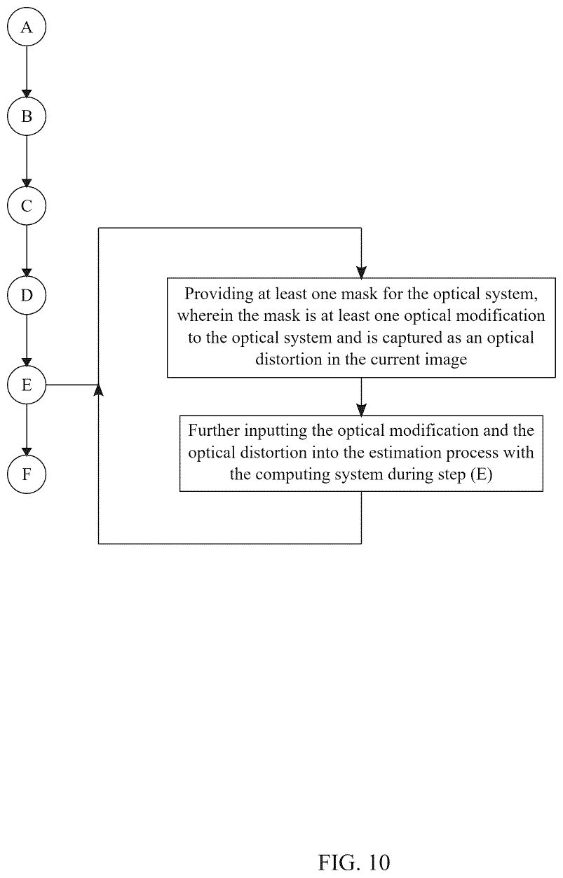

As can be seen in FIG. 10, another subprocess for the method of the present invention is provided with at least one mask for the optical system. The mask is also used to sample the divergent beam and/or the convergent beam. This mask (i.e., potentially with complex geometry, multiple apertures, and even embedded optical elements) can also be moved within the divergent beam and/or the convergent beam. The mask is at least one optical modification to the optical system and is captured as an optical distortion in the current image. Thus, this subprocess is executed by further inputting the optical modification and the optical distortion into the estimation process with the computing system during Step E. In some embodiments, spatial filters (e.g., a mask with a specific hole) can be used to isolate selected multiple reflections within a transmissive optic. This enables ML (or wavefront sensing) to recover surface information and can also be used to measure thickness and wedge properties of the part under test.

Another subprocess for the method of the present invention specifies the overall process for using multiple beam transceivers in order to improve the measurement of the surface profile. Thus, this subprocess provides the at least one beam transceivers as a plurality of beam transceivers and the at least one testing surface as a single testing surface. Each of the plurality beam transceivers comprises a beam source and a beam receiver. More specifically, the plurality of beam transceivers may include a first beam transceiver and a second beam transceiver. A transmission optical path travels from the beam source of the first beam transceiver, to the single testing surface, to the at least one referenceable collimator, back to the single testing surface, and to the beam receiver of the first beam transceiver. A reflection optical path travels from the beam source of the second beam transceiver, to the single testing surface, to the at least one referenceable collimator, back to the single testing surface, and to the beam receiver of second beam transceiver. As further explanation, the idea of combining reflective and transmissive Ritchey-Common tests (i.e., with one or two mirrors and one or several sensors and sources) is applicable not only to the machine-learning-based inverse model but is also applicable to traditional wavefront measurement techniques (e.g., interferometry or wavefront sensors) followed by data reduction.

### Supplemental Description

Using RC test mapping formulas (exact or approximated) or ray tracing techniques, one can compute the return incoming beam and its wavefront for a given profile of the surface under test. By applying scalar diffraction theory, one can then compute the image formed by the incoming beam at or near the spherical mirror CC. In the context of phase retrieval, a defocused image is typically used, either intra or extra-focal, though other phase modulations can also be used. The general idea disclosed here is to use such an image to directly retrieve the surface profile without having to map it from the wavefront, not even needing to know the wavefront. However, the wavefront can also be retrieved if needed. One interesting aspect of using image space wavefront sensing (also known as phase retrieval when using a single image and phase diversity if one uses several images at different defocus positions) is that for weak incoming return beams, any intensity mismatch between the incoming and outgoing (reference) beams does not need to be faced nor dealt with as one would with interferometry. This issue can be quite challenging if the surface is uncoated (clear) since the return beam could exhibit very low intensity. In the context of image space wavefront sensing, there is no interference, and the signal-to-noise ratio (SNR) can always be improved by increasing the exposure time of the camera capturing the image of the incoming beam. Also, since there is no interference, by nature this approach is very robust against vibration and other artefacts.

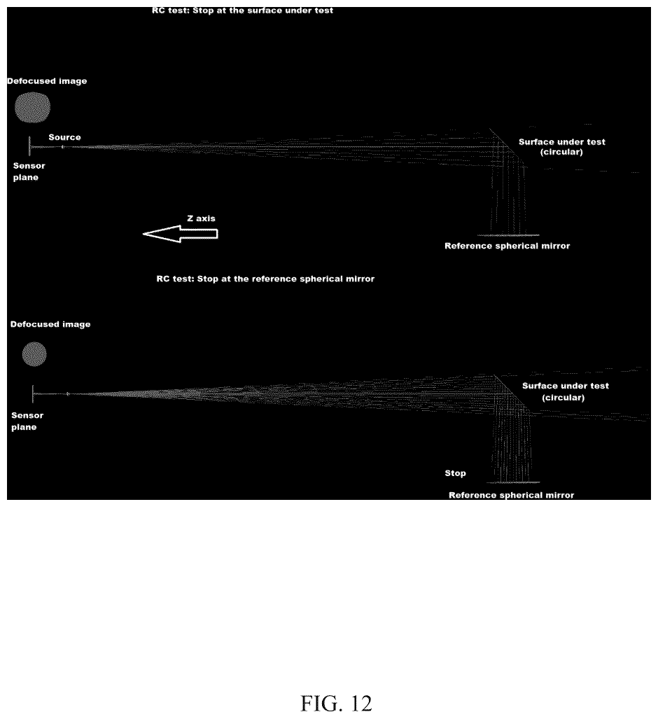

For simplicity, assume the surface under test is circular, and its deviation from a perfect flat surface is described by a set of Zernike polynomials and their coefficients. This is not a limitation of the method; other shapes can also be used. Additionally, other methods for describing surface deviation from flatness can be employed besides Zernike polynomials. For instance, one could sample the surface at specific known locations instead of using the Zernike parametric description. The Zernike polynomial parametric surface departure description can also be combined with other methods. In the context of a circular surface and using Zernike polynomials, the incoming wavefront error can be computed due to the surface under test using ray tracing, for instance. This calculation uses the Zernike polynomials related to the surface under test and the knowledge of the test setup (theta angle, spherical mirror, including its own surface error, as well as the entire test system geometry). In short, this means that the wavefront error WF(u,v) of the incoming beam at some location along the return path after the second reflection from the surface under test is a function of the surface S(x,y) departure (error) from a flat surface. Here, x and y refer to the 2D position on the surface under test, and u and v to the 2D position on the wavefront error measured on a plane orthogonal to the return beam path at some location z along it. This results in WF(u,v,z)=fmap(S(x,y)) where fmap is the function relating the surface errors to the wavefront error (departure between a perfect spherical wavefront and the actual wavefront). As mentioned before, for image space phase retrieval, one typically uses a defocused image (this is not a limitation of the method here other phase modulation could be used) either before the mirror CC or after the mirror CC. By choosing the z value to be close to the spherical mirror CC with some known defocus modulation (some distance away from CC), the wavefront of the incoming (return) beam can be computed using exact ray tracing calculations (or some mapping functions) and then the diffraction pattern using the Fourier transform of the WF. The WF is obviously limited in extension by the surface under test diameter d or by the spherical mirror diameter D. One of them acts as a stop in the system. In the most common situation, the surface acts as a stop, which means that the WF is defined (non-zero) inside an elliptical-like shape (resulting from the mapping of the circular surface for a given theta angle, spherical mirror radius, and diameter D). FIG. 12 shows both cases with a system stop defined by the circular surface under test or by the spherical mirror.

When the circular surface under test (circular is just an example, not a limitation) is the system's stop, it can be clearly seen that the resulting defocused image is elliptical in nature. Its exact shape is more complex than an ellipse because the surface stops a divergent spherical beam. When a circular stop is placed in front of the spherical mirror, becoming the system's stop, as expected, a round (circular) defocused image is shown.

The shape of the defocused image does not matter for the description of this method. When creating the samples for the training, validation, and testing databases for the neural network (or any machine learning and function approximation tools) used by AI to learn the inverse function relating the defocused image to the Zernike polynomial coefficients (or other ways to describe the surface under test error/shape), any shape of the defocused image and therefore the surface under test will be automatically accounted for. It should be understood that using mapping functions or ray tracing, the return (incoming) beam phase error relative to a perfect spherical wavefront can be expressed (if there is no aberration and a perfectly flat surface).

The magnitude of the return beam can also be expressed, basically the region where it is non-zero (it is assumed that the uniform illumination of the surface under test is available, yet this is not a limitation; any beam shape, like a Gaussian beam as well, can be handled). This will define the pupil shape (circular, elliptical, or any other shape, including obstructions, if any) used to compute the diffracted defocused image through the 2D Fourier transform, as discussed above.

It should be understood that using the Fourier transform is a convenient way to compute the diffraction pattern (typically a defocused image), but other techniques can be used, especially in the context of large angles where sin(x)≈x(small angle approximation) and similar approximations cannot be assumed. The present invention is also not limited to scalar diffraction theory; although it is the most common approach in most applications, it is not a limitation of this method. All that is needed is to compute sufficiently accurate defocused images (including noise and artifacts, if any) to be able to compute the inverse function through machine learning (function approximation) relating the image to the surface under test to some level of accuracy.

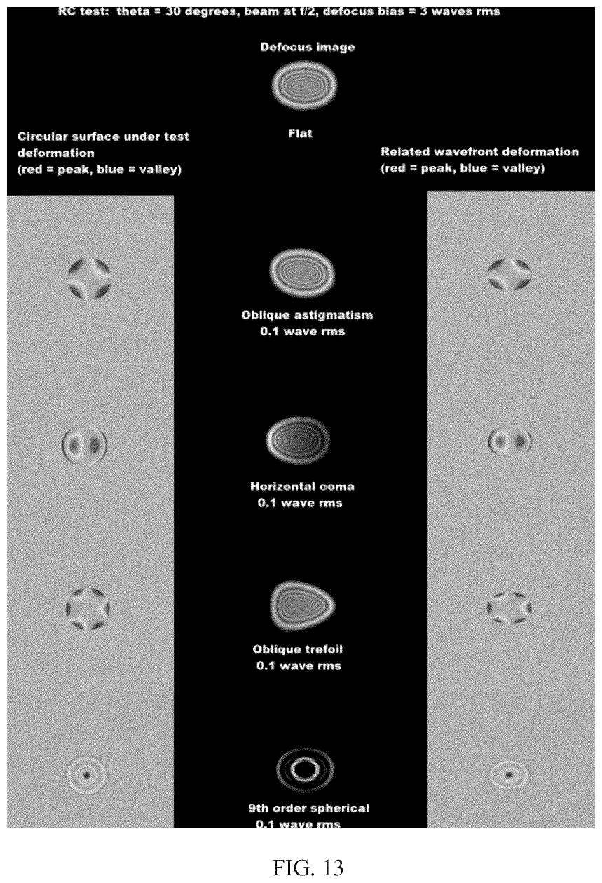

In FIG. 12, the sensor is placed behind the source on axis for simplicity. In practical implementation, one can use a beam splitter in front of the source to separate the outgoing and incoming beams, or slightly tilt the surface, or the mirror or the source, or use a combination of these methods to offset the return image from the source. This can be done with minimal aberrations, which, if present, can be subtracted after proper calibration. FIG. 13 shows some examples of defocused images for some basic deformations of a flat circular surface described by the Zernike polynomials. Here theta, Ritchey's angle, has been set to 30 degrees and the outgoing beam at f/2. The circular surface under test is the system's stop.

As discussed above, using ray tracing or other mapping functions, the return (incoming) beam wavefront and then the related defocused images (typically using the Fourier transform) for a given surface departure (from flat) are computed. This departure can be conveniently expressed with the Zernike polynomials (but this is not a limitation). By selecting a defocus bias (in this example, 3 wave RMS), the necessary phase modulation is created to ensure the uniqueness of the solution, meaning there is a unique image related to a unique wavefront and therefore to a unique surface departure (deformation). This ensures convergence to an accurate solution during the training of the neural network or equivalent function approximation tool.

A training, validation, and test database with only simulated images is typically built; actual images for this method are not needed (although some synthetic images can be used or mixed with actual ones if chosen). Pure simulations using the above mathematics allow for the creation of many samples (many millions) in order to sample well the inverse function for a set of Zernike polynomials and related coefficients used to describe the surface departure (or other methods). This is essentially identical to the approach used in Innovations Foresight's AI4Wave technology. Here, the surface is reconstructed instead of the wavefront from the image (both could be done as well). This is a direct approach that does not need to solve any non-linear problems or equivalents at run time. Once the training of the neural network has been done and validated, the calculation of the surface departure (the Zernike coefficients or similar) from a given defocused image is extremely fast, taking only a few milliseconds on most simple PCs. Another important point to mention is that since there is no run-time optimization, local minima and good enough initial guesses do not have to be dealt with. All the performance, accuracy, and bias were already validated during the training of the neural network, or any relevant function approximation algorithms. This validation of the performance can be done with as many samples as wanted since they can be computed.

So far, the RC test has been considered to measure the reflection of a flat surface. However, the same concept can be used to measure both the surface and the thickness, as well as the wedge, of both sides of an opaque (yet reflective) surface or, more interestingly, a transparent flat window of any shape. For simplicity, a circular window is being considered, but this is not a limitation.

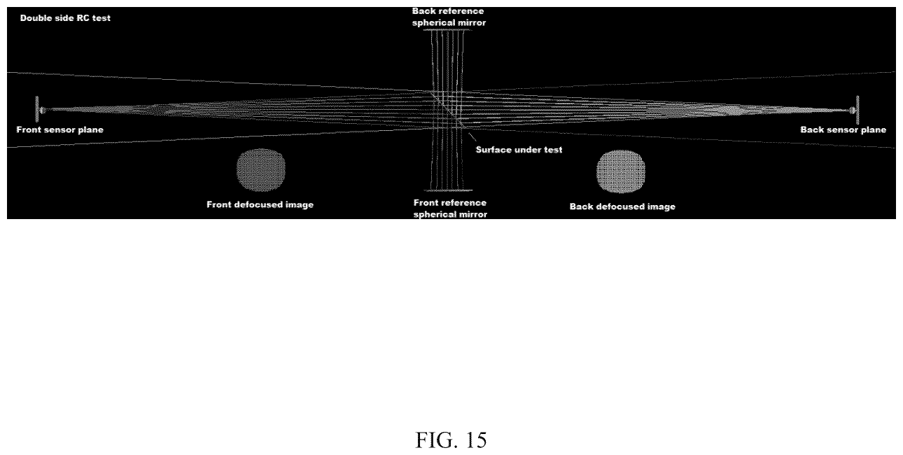

The simplest approach would be to use two RC tests based on the specular reflection of the window, as shown in FIG. 15 (with theta set at 45 degrees for convenience). The first spherical outgoing beam is depicted in red, while the second is in green.

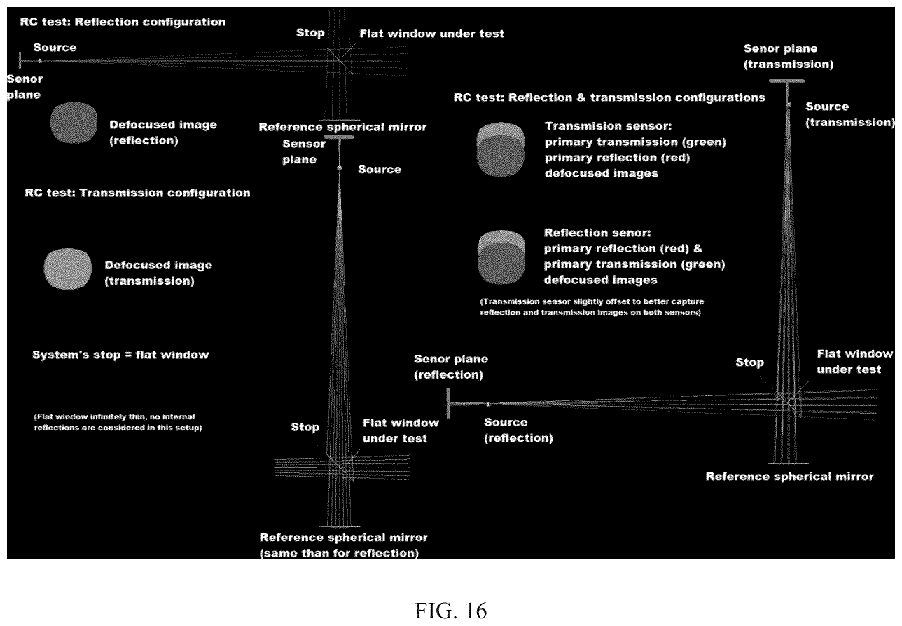

One drawback of this approach is the need for two reference spherical mirrors and sources. In the context of a transparent flat window under test, there is the option to use a reflective and transmissive test. The former is a classic RC test, while the latter is a modified version of the RC test. FIG. 16 shows the concept (with theta set at 45 degrees for convenience). The reflected rays are depicted in red, while the transmitted rays are in green. However, for both sources (RC test on reflection, red rays, and on transmission, green rays), both reflections and transmissions on each sensor are observed. There is only a single reference spherical mirror.

Each sensor—one for the reflection RC test side and one for the transmission RC test side—exhibits two defocused images with the same shape (system's stop at the level of the flat window). These are the primary reflection and transmission images. For simplicity, the thickness of the flat window is considered to be infinitely small, so there are no internal reflections.

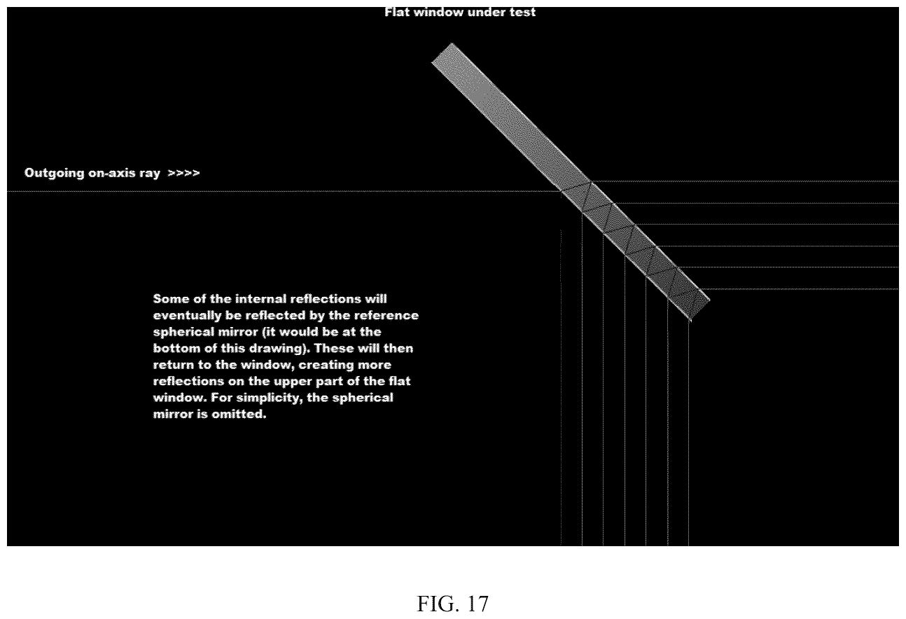

FIG. 17 shows the internal reflections for an on-axis ray from the reflection RC test source (on the left). These reflections also occur for the transmission RC test. They can be addressed by using a spacial filter near the mirror CCs if there is any overlap between the defocused images and their internal reflections. Such a filter is essentially a circular hole of the proper size to allow the primary incoming beams (reflection and transmission) to pass through while blocking the reflections. The latter are separated by some distance (translation) related to theta, the window thickness, and its index of refraction. For the present invention, such reflections will not be considered since they can be filtered out or ignored by cropping the proper subframe on each sensor. However, they are mentioned here because they can also be conveniently used to gather more information about the flat window under test if necessary. For instance, the translation distance of such internal reflection images tells us about the window thickness, among other things. It should be understood by anyone skilled in the art of engineering that such images could be processed from these reflections in the same manner using AI, or equivalent tools, to retrieve information about the flat window's surfaces, thickness, and wedge angle. This may improve accuracy and SNR, for instance. Those reflections can be combined with the primary image or not depending on the context.

In the context of the RC test in reflection and transmission depicted in FIG. 16, reflection and transmission information is obtained even with a single source. The decision to use one or two sources depends on the nature of the information to be retrieved and the nature of the surface under test. In short, a single source could be used (either the reflection or transmission one) if there is no ambiguity in the wavefront reconstruction when using the defocused image, or images, and therefore no ambiguity in the information being looked for, such as surface departure from flatness, thickness, or wedge. A single sensor could also be used with a single source or any combination of those (one/two sources, one/two sensors). The final decision is related to the above question of the uniqueness of the solution for the inverse problem, known information on the surfaces, constraints, as well as SNR and test geometry. Therefore, it should be understood that even if a system with two sources and two sensors is described, this is not a limitation of the method but rather a general description using some implementation (embodiment).

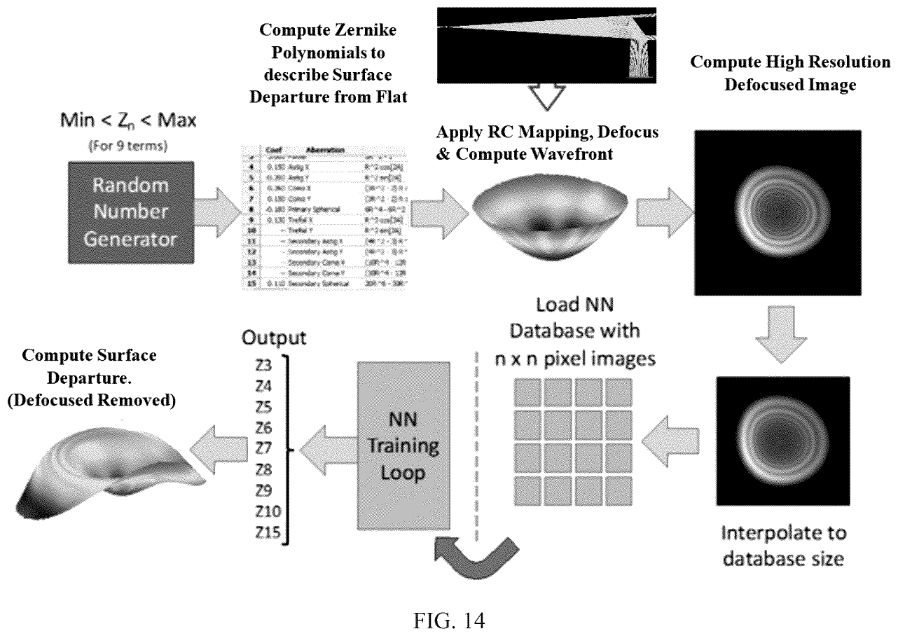

When having more than one image (from one or more sensor, or over time, or from several wavelengths, or a combination), data fusion for the artificial neural network (ANN) or a similar function approximation tool can be done in different ways, including using one or multiple ANNs. In one embodiment, a unique composite image features several defocused images from one or two sensors, or more and one or two sources, or more, or over time, or over wavelengths (including all combinations). This composite image is provided to the ANN for calculating the characteristics of the surface under test, like depicted in FIG. 14. Among the outputs, but not limited to, will be the first side surface departure or equivalent from flatness or any expected profile or just the absolute profile. This can be done, for instance, using the Zernike polynomials as in FIG. 14, but this is merely an example, not a limitation. Other information could include the second (other) side surface departure from flatness or any expected profile or just the absolute profile. The surface under test thickness and any wedge may also want to be extracted. Other information may be extracted, such as surface index of refraction, material index of refraction, or several indices of refraction in the surface is made of various material or gradient of index of refraction as well as the optical extinction in the context of a somewhat transparent window. The surface polarization effect in terms of reflection and/or transmission may also want to be known. The existence of surface defects (localized high spatial frequencies, defects, or structures) as well as any internal defects or scattering properties may also be estimated from the composite image. Monochromatic illumination implementations are described, but this is not a limitation either. Several wavelengths or a broad spectrum or a combination of any sources could be obtained. Other sources located at different positions with other sensors could also be obtained; the typical configuration of two sources presented here is not a limitation either. In the context of several ANNs, one could be fed from the output of another or be provided several separate images to a given ANN instead of a single composite image. Any combination of these is possible depending on the problem and expected performance. It is also possible to use ANN or equivalent as time series to process images and/or data from iterations. One possible implementation could be similar to transformers used in language models. All the above implementations, combinations, and permutations are understood to be well known by anyone skilled in the art of machine learning and optimization.

In some situations, both the entire surface under test as described in the above example and discussion or a smaller area of the surface on either side may want, with the same system, to be measured. In this context, a novel approach is described using a movable stop of some shape conveniently designed to measure some defined area shape (like a disk, a rectangle, an ellipse, or any other shape) of the surface under test. The stop could be made of several non-adjacent holes too; it is not limited to a single one, whatever its shape. Such a stop may be moved to measure or scan the surface at several locations, with or without overlaps. The stop could have a variable shape and/or size too. A convenient location for such a stop, but not a limitation, is to place it in front of the reference spherical mirror. Several stops combined with several spherical mirrors could also be obtained.

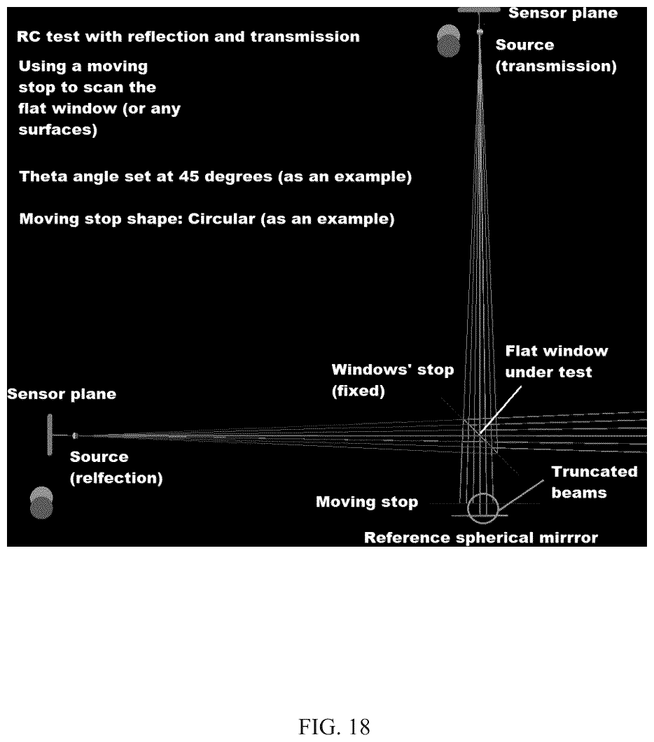

FIG. 18 below shows an implementation, as an example, in the context of the RC test combining reflection and transmission as depicted in FIG. 16. Here the stop is placed in front of the unique reference spherical mirror. It is understood that the stop can be moved freely in any direction (3D) and its shape changed as well. FIG. 18 is just an example, not a limitation, of such an implementation. The number of sources, mirrors, sensors, and stops, their shapes and positions, as well as the wavelengths in use, can all be tailored for a given goal.

One very interesting feature of having a movable, or/and changing shape, stop is the ability to combine full-surface measurements, or several image with different stop configurations and locations, or both, with local data from image taken with a stop in place (smaller aera in the surface under test). This allows the separation of any defocus errors seen by the image (or interferograms or any other means) from the RC test setup versus any power (quadratic departure) from the surface under test. In a normal RC test, at least two data sets (images, or interferogram, or others) in different configurations need to be taken, for instance, by rotating the surface under test or changing the angle theta, or both, to separate any defocus observed in the image between the surface under test contribution and the setup defocus error contribution.

The moving stop provides a very convenient way to solve this issue without moving anything else but the stop or just changing the stop shape, or both. This offers a valuable advantage in terms of accuracy and speed. A small stop also allows retrieving high spatial frequency properties of the surface under test, such as roughness. It should be remembered that the defocused image (or phase-modulated engineered image) carries a lot of information about the wavefront phase, and therefore the surface departure in the present invention's case, besides piston. This includes roughness as well. It is understood that the images from the moving stop can be processed in the same way as the full surface images. Combining full images and/or stitching the images from the moving stop are options as well. The stop could be equipped with some optics or CGH in some configurations. A mask could also be used instead of a simple stop near the reference spherical mirror (or elsewhere in the system, or several masks) for performing sparse aperture imaging and interferometry (like a Hartmann's mask, for example) and/or as a coded aperture. Such a mask, or masks, could be moved and/or changed over time.

Finally, some auxiliary optics that can be used for magnification of the image for a given camera and sensor pixel size, or to perform wavelength and/or spatial filtering have been omitted. These include the possibility to correct for coma and astigmatism in the context of a diverging spherical wave passing through a transparent flat surface (a window). Such optics could be used to cancel these known aberrations for the nominal, expected thickness, wedge and index of refraction of the window so that the image will only carry departures from those values and the surface itself. Total or partial cancelation of the wavefront errors due to the system optical aberrations and/or the transmission through the flat window can be done in many ways, including by using computer-generated holograms (CGH). All possible auxiliary optics are well known to anyone skilled in the art of optics.

Although the invention has been explained in relation to its preferred embodiment, it is to be understood that many other possible modifications and variations can be made without departing from the spirit and scope of the invention.

What is claimed is:

1. A method of measuring an optical surface by collimating a divergent beam, the method comprising the steps of:
(A) providing a computing system and at least one optical system, wherein the optical system includes at least one beam transceiver, at least one testing surface, and at least one referenceable collimator, and wherein the computing system and the beam transceiver are communicably coupled to each other, and wherein the beam transceiver, the testing surface, and the beam collimator are in optical communication with each other;
(B) emitting a divergent beam from the beam transceiver, to the testing surface, and to the referenceable collimator in order to convert the divergent beam into a convergent beam;
(C) reflecting the convergent beam from the referenceable collimator, to the testing surface, and to the beam transceiver;
(D) capturing a current image of the convergent beam with the beam transceiver;
(E) executing an estimation process with the computing system by inputting the current image into the estimation process; and
(F) further executing the estimation process with the computing system by outputting a surface profile of the testing surface with the estimation process.

2. The method as claimed in claim 1 further comprising the steps of:
providing the optical system arranged in a Ritchey-Common test configuration, wherein the referenceable collimator is a spherical mirror, and wherein the beam transceiver is positioned along a curvature centerline of the spherical mirror, and wherein the testing surface is a flat surface, and wherein an angle theta is defined by the Ritchey-Common test configuration;
emitting the divergent beam at the angle theta to the testing surface during step (B);
reflecting the convergent beam at the angle theta to the testing surface during step (C);
capturing a defocused image as the current image with the beam transceiver during step (D); and
further inputting the angle theta into the estimation process with the computing system during step (E).

3. The method as claimed in claim 1, the method further comprising the steps of:
providing an image-quality baseline and a standard exposure time stored on the computing system;
exposing the current image for the standard exposure time with the beam transceiver during step (D), if a signal-to-noise ratio of the current image is greater or equal to the image-quality baseline; and
exposing the current image longer than the standard exposure time with the beam transceiver during step (D), if the signal-to-noise ratio of the current image is less than the image-quality baseline.

4. The method as claimed in claim 1, the method further comprising the steps of:
providing the estimation process with a non-linear mapping function between an image of the convergent beam and a surface profile of the testing surface; and
outputting the surface profile with the computing system during step (F) by inputting the current image through the non-linear mapping function.

5. The method as claimed in claim 4, the method further comprising the steps of:
providing an artificial intelligence model managed by the computing system;
training the artificial intelligence model to generate an inverse mapping function with the computing system by regressively applying at least one mathematical parameter to at least one previous image of the convergent beam; and
further training the artificial intelligence model to approximate the non-linear mapping function based on the inverse mapping function with the computing system.

6. The method as claimed in claim 5, wherein the mathematical parameter is the Zernike polynomial coefficients.

7. The method as claimed in claim 1, the method further comprising the step of:
estimating at least one surface characteristic of the testing surface from the surface profile with the computing device after step (F).

8. The method as claimed in claim 7, wherein the surface characteristic is a deviation from flatness.

9. The method as claimed in claim 7, wherein the surface characteristic is a surface thickness.

10. The method as claimed in claim 7, wherein the surface characteristic is an index of refraction.

11. The method as claimed in claim 7, wherein the surface characteristic is a level of transparency.

12. The method as claimed in claim 7, wherein the surface characteristic is a surface polarization.

13. The method as claimed in claim 1, the method further comprising the steps of:
providing at least one stop for the optical system, wherein the stop is at least one optical modification to the optical system and is captured as an optical distortion in the current image; and
further inputting the optical modification and the optical distortion into the estimation process with the computing system during step (E).

14. The method as claimed in claim 1, the method further comprising the steps of:
providing at least one stop for the optical system, wherein the stop is moved to a plurality of locations in the optical system, and wherein each location is an optical modification to the optical system and is captured as an optical distortion in the current image; and
further inputting the optical modification of each location and the optical distortion of each location into the estimation process with the computing system during step (E).

15. The method as claimed in claim 1, the method further comprising the steps of:
providing at least one mask for the optical system, wherein the mask is at least one optical modification to the optical system and is captured as an optical distortion in the current image; and
further inputting the optical modification and the optical distortion into the estimation process with the computing system during step (E).

16. The method as claimed in claim 1, wherein the at least one beam transceivers is a plurality of beam transceivers, and wherein each of the plurality beam transceivers comprises a beam source and a beam receiver, and wherein the at least one testing surface is a single testing surface.

17. The method as claimed in claim 16, wherein the plurality of beam transceivers includes a first beam transceiver and a second beam transceiver, and wherein a transmission optical path travels from the beam source of the first beam transceiver, to the single testing surface, to the at least one referenceable collimator, back to the single testing surface, and to the beam receiver of the first beam transceiver, and wherein a reflection optical path travels from the beam source of the second beam transceiver, to the single testing surface, to the at least one referenceable collimator, back to the single testing surface, and to the beam receiver of second beam transceiver.
